(19) United States
(12) Patent Application Publication
(10) Pub. No.: US 2020/0253422 A1
(43) Pub. Date: Aug. 13, 2020

(54) GRILL AND SMOKER CONVERTIBLE CONFIGURATION DEVICE AND METHOD

(71) Applicant: Robert V. Suchevits, Cheswick, PA (US)

(72) Inventor: Robert V. Suchevits, Cheswick, PA (US)

(21) Appl. No.: 16/862,755

(22) Filed: Apr. 30, 2020

Related U.S. Application Data
(63) Continuation of application No. 15/850,251, filed on Dec. 21, 2017.
Application No. 15/850,251 is a continuation-in-part of application No. 14/302,072, filed on Jun. 11, 2014, now abandoned.

(51) Int. Cl. A47J 37/07; A23B 4/052; A47J 36/06

(52) U.S. Cl. CPC A47J 37/0786; A47J 36/06; A23B 4/052; A47J 37/0704

(57) ABSTRACT

A grill converter device may include a plurality of cover sections. Each cover section may be removably connected to each other cover section by a plurality of fasteners. At least one airflow regulator hole may be positioned along a side of at least one of the plurality of cover sections. At least one airflow regulator cover may removably cover the at least one airflow regulator hole. When adding a smoke box on a grill, the grill converter device allows for control over the smoking process. The conversion may allow for a controlled adjustment of the smoke inside a lid of a grill.

### CROSS REFERENCE TO RELATED APPLICATION

This application is a continuation-in-part application of and claims priority to U.S. patent application Ser. No. 14/302,072, filed Jun. 11, 2014, entitled Grill and Smoker Convertible Configuration Device and Method.

### BACKGROUND OF THE INVENTION

### Field of the Invention

The disclosed and claimed concept relates to a converter device and, more particularly, to a grill converter device that is structured to convert a grill to a smoker.

### Background Information

The present invention relates to grills and smokers and, more particularly, to a grill and smoker convertible configuration device and method. Generally, a grill is a cooking device structured to heat food at high temperatures and which does not intentionally contain the smoke associated with cooking. That is, a grill includes a number of outlets structured to exhaust smoke. Further, heat also escapes with the smoke. Conversely, a smoker is structured to maintain smoke and heat in close proximity to food thereby imparting a smoke flavor to the food.

Currently, smokers for a bar-b-que are expensive, labor intensive and quite large. Many people enjoy smoked foods and sauces, but cannot afford or do not have the extra space for a full-size smoker. A smoke box, i.e., an enclosure structured to hold wood chips or other fuels that produce smoke, alone on a grill does not allow for smoking a food at a controlled temperature or have a containment of the smoke. Instead, any smoke that is created is quickly exhausted from the grill. Gas usage is high to keep at an optimal smoking temperature.

As can be seen, there is a need for a grill and smoker convertible configuration device and method that allows the grill to burn at a low setting on a smoke box and containing the smoke at an optimal temperature increasing the smoking at a lower gas cost.

### SUMMARY OF THE INVENTION

In one aspect of the present invention, a grill converter device comprises: a plurality of cover sections, wherein each cover section is removably connected to each other cover section by a plurality of fasteners; at least one airflow regulator hole positioned along a side of at least one of the plurality of cover sections; and at least one airflow regulator cover, wherein the at least one airflow regulator hole is removably covered by the at least one airflow regulator cover.

In another aspect of the present invention, a method for converting a grill to a smoker configuration comprises: placing a grill converter device on a lid of the grill, wherein the grill converter device comprises a plurality of cover sections, wherein each cover section is removably connected to each other cover section by a plurality of fasteners; at least one airflow regulator hole positioned along a side of at least one of the plurality of cover sections; and at least one airflow regulator cover, wherein the at least one airflow regulator hole is removably covered by the at least one airflow regulator cover; tightening all fasteners to secure the grill converter device to the lid; placing a smoke box directly over an open flame set on a lowest setting; and adjusting the airflow regulator cover in conjunction with a burner control temperature as needed.

These and other features, aspects and advantages of the present invention will become better understood with reference to the following drawings, description and claims.

### BRIEF DESCRIPTION OF THE DRAWINGS

A full understanding of the invention can be gained from the following description of the preferred embodiments when read in conjunction with the accompanying drawings in which:

FIG. 1 is a schematic perspective view of an exemplary embodiment of the present invention, shown in use;

FIG. 2 is a schematic perspective view of an exemplary embodiment of the present invention;

FIG. 3 is a schematic exploded view of an exemplary embodiment of the present invention;

FIG. 4 is a schematic section view of an exemplary embodiment of the present invention, taken along line 4-4 in FIG. 1; and

FIG. 5 is a schematic section view of an exemplary embodiment of the present invention, illustrating the movement.

FIG. 6 is a schematic perspective view of another exemplary embodiment of the present invention.

### DESCRIPTION OF THE PREFERRED EMBODIMENTS

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a grill converter device that may include a plurality of cover sections. Each cover section may be removably connected to each other cover section by a plurality of fasteners. At least one airflow regulator hole may be positioned along a side of at least one of the plurality of cover sections. At least one airflow regulator cover may removably cover the at least one airflow regulator hole. When adding a smoke box on a grill, the grill converter device allows for control over the smoking process. The conversion may allow for a controlled adjustment of the smoke inside a lid of a grill.

The present invention may convert a backyard grill into a low-cost smoker with components that you can fold down into something that may fit into a drawer or the like for storage. The device may control the temperature and contain the desired amount of smoke that the grill creates by utilizing the inherent insulation of fireproof/fire-retardant materials therein. The present invention may lower the cost of smoking food on a grill and eliminate the purchase of a big, bulky smoker. The present invention may wrap itself around a grill lid, but still allow the user to check the food because it may not interfere with the motion of the lid itself.

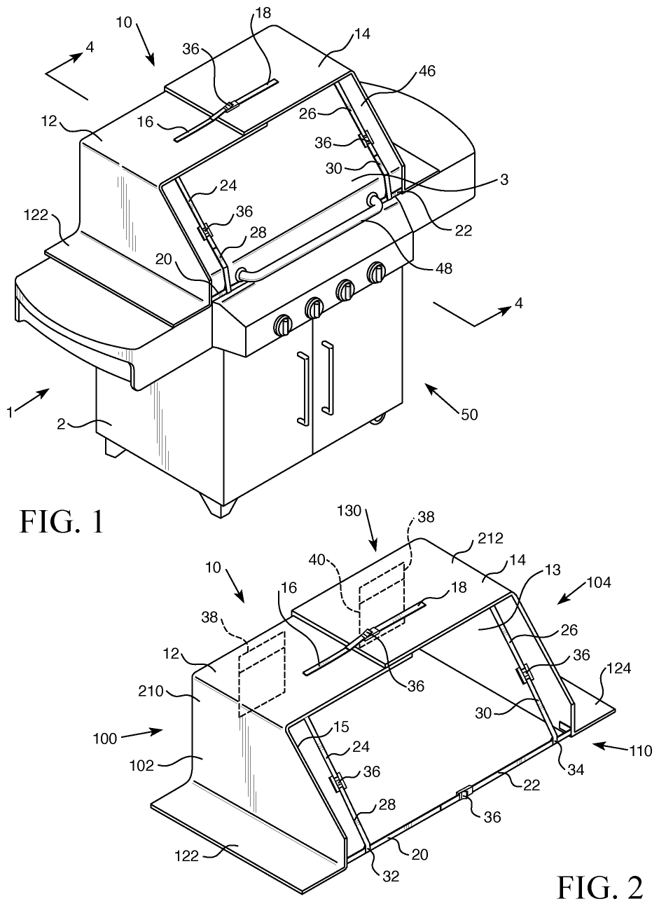

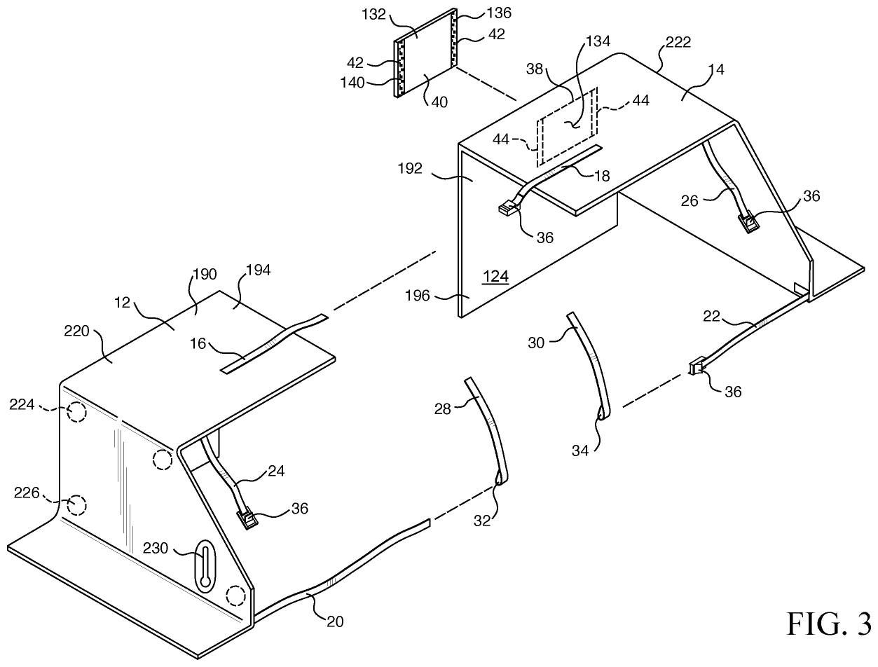

As is illustrated in FIGS. 1 through 5, a grill converter device 10 may include a plurality of cover sections, at least one airflow regulator cover 40 and at least one airflow regulator hole 38. In certain embodiments, the plurality of cover sections may include a first cover section 12 and a second cover section 14. The first cover section 12 and the second cover section 14 may be removably connected by a plurality of fasteners. The first cover section 12 may have a shape that may cover a portion of a grill lid 46. The second cover section 14 may have a shape that may cover another portion of the grill lid 46. Fasteners, such as, but not limited to, straps and buckles 36, may removably secure the first cover section 12 to the second cover section 14. In certain embodiments, a first upper strap 16 may connect with a second upper strap 18 with a buckle 36. In certain embodiments, a first front strap 28 and a second front strap 30 may be disposed proximate a front side of a grill 1. A first loop 32 may be attached to the first front strap 28. A second loop 34 may be attached to the second front strap 30. A first lower strap 20 and a second lower strap 22 may slide into the first loop 32 and the second loop 34, respectively. The first lower strap 20 and the second lower strap 22 may then connect with a buckle 36. In certain embodiments, the first lower strap 20 and the second lower strap 22 may be placed below a grill lid handle 48. In certain embodiments, a first side strap 24 may connect with the first front strap 28 with a buckle 36. In certain embodiments, a second side strap 26 may connect with the second front strap 30 with a buckle 36. The straps, that may be adjustable, and the first cover section 12 and the second cover section 14, may allow for the device 10 to be placed on most models of grills 1. The first cover section 12 and the second cover section 14 may fold down flat to be stored in a drawer or the like. It is understood that the “buckle 36” is exemplary and that other types of couplings, such as, but not limited to buttons, hooks, clips and zippers, are used in other exemplary embodiments.

In certain embodiments, the at least one airflow regulator hole 38 may be on at least one side of the plurality of cover sections. The airflow regulator hole 38 may be adjustably covered by the airflow regulator cover 40. The airflow regulator cover 40 may be adjusted to expose the airflow regulator hole 38 in varying degrees from a fully closed position through to a fully open position and any position in between. The at least one airflow regulator cover 40 may be removably attached to approximately just outside of the at least one airflow regulator hole 38 by fasteners such as hooked fastener strips 42 and looped fastener strips 44, and the like.

A method of using the present invention may include the following. A user may place the device 10 on a grill 1, such as a gas grill or the like. The user may then tighten all the fasteners so that the device 10 may wrap, or grip the grill lid 46. The device 10 may be made from fireproof/fire retardant material for the airflow regulator cover 40, the first cover section 12 and the second cover section 14. The straps may also be made from fireproof/fire retardant material. The smoking process may include having a box filled with water soaked wood chips that may be placed directly over an open flame set on a lowest setting. During the smoking process, the user may adjust the opening from the at least one airflow regulator hole 38 by moving the at least one airflow regulator cover 40 in conjunction with a burner control temperature as needed.

It should be understood, of course, that the foregoing relates to exemplary embodiments of the invention and that modifications may be made without departing from the spirit and scope of the invention as set forth in the following claims.

As a further description of the grill converter device 10 disclosed above, the grill converter device 10 is structured to, and does, convert a “grill” into a “smoker.” As used herein, a “grill” means a construct structured to cook food. That is, a “grill” is not simple a frame with spaced bars upon which food is placed. Instead, a “grill” as use herein includes an enclosure within which a heat source and a “cooking grill” is disposed. As used herein, a “cooking grill” means a frame with spaced bars upon which food is placed. Further, a “grill” enclosure is configurable and inherently includes a base and a lid which define an enclosed space. That is, as used herein, a “grill” inherently includes an enclosed space. The lid is, in one embodiment, separable from the base. In another embodiment, the lid is pivotally coupled to the base. In either configuration, and as used herein, a “grill” is structured to move between two configurations; a closed, first configuration, wherein the lid is disposed over and immediately adjacent to the base and wherein the lid and base form a substantially enclosed space, and, an open, second configuration, wherein the lid is not disposed over and immediately adjacent to the base and wherein the lid allows for access to the enclosed space. In an embodiment wherein the lid is pivotally coupled to the base, and as used herein, a lid is pivotally coupled adjacent the rear, or back, side of the base. Further, as used herein, the “grill,” i.e., the lid and/or the base, inherently include a number of inlets and outlets. As is known, the inlets and the outlets provide a path for fluid communication when the lid is in the first configuration. In an embodiment wherein the lid and the base do not fit well together, there is also a path for fluid communication at the interface between the base and the lid. The inlets and/or outlet, in some embodiments, include a valve assembly structured to alter the cross-sectional area of the inlet/outlet passage. As is known, changing the cross-sectional area of the inlet/outlet passage alters the amount of fluid that passes through the inlet/outlet. Thus, the inlets/outlets are structured to provide a minimum and maximum fluid flow rate through the grill enclosed space. That is, as used herein, a “grill” inherently has a minimum and maximum flow rate through the grill enclosed space that is controlled by inlets/outlets when the lid is in the first configuration.

As used herein, an “inlet” on a “grill” is a passage generally disposed on the lower portion of the “grill” and which is structured to allow air from outside the grill enclosed space into the grill enclosed space.

As used herein, an “outlet” on a “grill” is a passage generally disposed on the upper portion of the “grill” and which is structured to allow fluid and smoke from the grill enclosed space out of the grill enclosed space. Further, an “outlet” can be either “blocked” or “unblocked.” As used herein, a “blocked” outlet means an outlet having an obstruction in the fluid path of the outlet which substantially limits the cross-sectional area of the fluid path either in, or immediately adjacent, an inlet or outlet. An “unblocked” outlet means that the fluid path of the inlet/outlet does not have an obstruction that limits the cross-sectional area of the fluid path.

As used herein, a “smoker” means a construct including an enclosed space with a limited number of unblocked outlets. As used herein, a “limited number” means less than on a “grill” when that same “grill” is not coupled to a “grill converter device” in a use configuration, as defined below.

As used herein a “grill converter device” is structured to, and does, convert a cooking device from a “grill” to a “smoker.” Thus, a “grill converter device” is structured to, and does, convert a number of “unblocked” grill outlets to be “blocked” grill outlets. That is, a “grill converter device” is structured to, and does, selectively block a number of grill outlets. To “block a number of grill outlets,” as used herein, means that the obstruction of the grill outlet is disposed adjacent, or immediately adjacent, a specific grill outlet. Thus, for example, a loose fitting weather cover for a grill which obstructs a direct path generally near a grill outlet but which does not specifically and substantially block a selected grill outlet is not, as used herein, a “grill converter device.” Further, as used herein a “grill converter device” is a construct that is coupled to a “grill” and is not part of the original “grill.” Thus, a valve assembly on a grill outlet is not, as used herein, a “grill converter device” as such a valve assembly is part of the original grill. Further, as used herein, a “grill converter device” is structured to be used when the grill heat source is in operation. As such, a protective cover for a grill, e.g., a cover structured to protect a grill from the weather, is not, as used herein, a “grill converter device.” This is true even if the protective cover is made from a heat resistant material as it is understood that use of such a heat resistant material is to protect the protective cover should the protective cover be placed on a grill that is still hot after use. That is, such a protective cover is not intended to be in place “when the grill heat source is in operation.” Further, as used herein, an “insulated grill converter device” means a “grill converter device” that is further structured to, and which does, insulate a portion of a “grill.”

As used herein, the singular form of “a,” “an,” and “the” include plural references unless the context clearly dictates otherwise.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hub caps. While all the elements are coupled as part of the automobile, it is understood that each hubcap is “associated” with a specific tire.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto. As a further example, a construct that is fitted to another object and which is maintained in position partially by gravity, is “coupled” to the object. That is, for example, a cover or “cozy” for a toaster is fitted to a toaster and, as such, is maintained substantially in place by the interface between the toaster and the cozy as well as gravity. As such, a cozy or other cover that is fitted or otherwise corresponds to the element covered, is “coupled” to the covered object.

As used herein, the phrase “removably coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, a “path of travel” or “path,” when used in association with an element that moves, includes the space an element moves through when in motion. A fluid “path” is the path the fluid moves along and may be defined by a structure or may be controlled by fluid directing devices such as, but not limited to a fan or nozzle. As such, any element that moves inherently has a “path of travel” or “path.” When used in association with an electrical current, a “path” includes the elements through which the current travels.

As used herein, the statement that two or more parts or components “engage” one another shall mean that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A either engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, the word “unitary” means a component that is created as a single piece or unit. That is, a component that includes pieces that are created separately and then coupled together as a unit is not a “unitary” component or body.

As used herein, the term “number” shall mean one or an integer greater than one (i.e., a plurality). Thus, a “number” of elements, as used herein, means a single element or a plurality of elements.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, “generally” means “in a general manner” relevant to the term being modified as would be understood by one of ordinary skill in the art.

As used herein, “substantially” means “for the most part” relevant to the term being modified as would be understood by one of ordinary skill in the art.

As used herein, “at” means on and/or near relevant to the term being modified as would be understood by one of ordinary skill in the art.

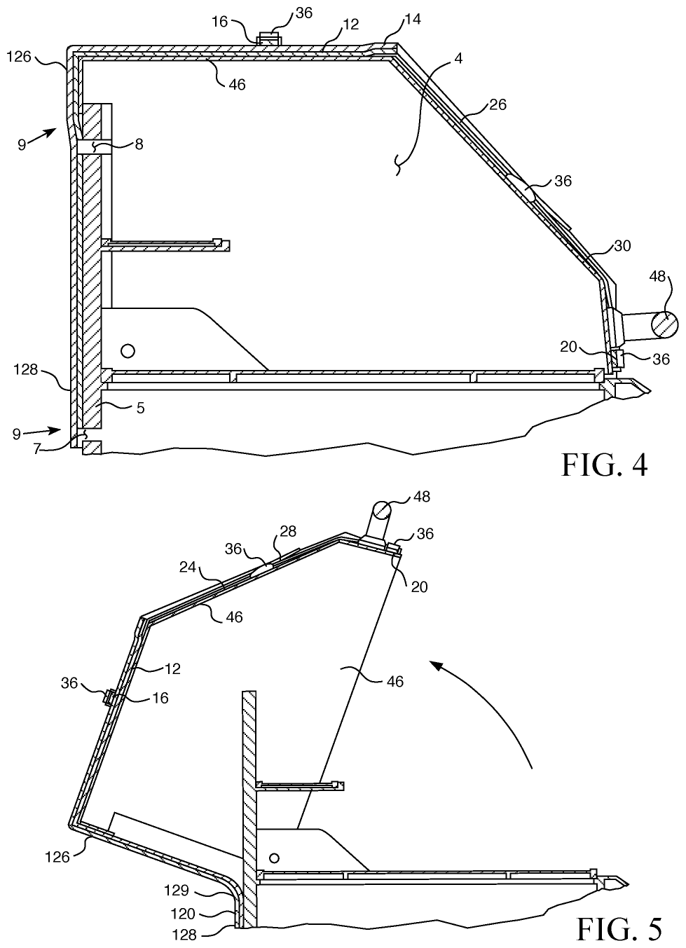

As shown in FIG. 1, a grill 1, in an exemplary embodiment, includes a frame 2 and a grill enclosure 3. The frame 2, in an exemplary embodiment, supports a fuel container (not shown), including a control assembly (not numbered) for a fuel system and defines a storage assembly (not numbered). As is known, the grill enclosure 3 defines an enclosed space 4 (FIG. 4). As shown in FIGS. 4 and 5, the grill enclosure 3 includes a base 5 and a lid 46. As is known, the lid 46 is pivotally coupled to a rear edge of the grill base 5. Thus, the lid 46, and therefore the grill 1, is structured to move between two configurations; a closed, first configuration, wherein the lid 46 is disposed over and immediately adjacent to the base 5 (FIG. 4) and wherein the lid 46 and base 5 form a substantially enclosed space, and, an open, second configuration, wherein the lid 46 is not disposed over and immediately adjacent to the base 5 (FIG. 5) and wherein the lid 46 allows for access to the enclosed space 4.

Further, as is known, a cooking grill (not numbered) and a number of burners (not shown) are disposed inside the enclosed space 4. The burners are coupled to, and in fluid communication with, the fuel container. In use, the fuel is ignited and burned at the burners. As such, in use, the enclosed space 4 becomes heated. The grill 1 also includes a number of inlets 7 and outlets 8, one of each shown. The inlets 7 are disposed generally on the lower portion of the enclosed space 4 and the outlets 8 are disposed on the upper portion of the enclosed space 4. In this configuration, the inlets 7 are structured to, and do, allow air to move from outside the enclosed space 4 into the enclosed space 4. The outlets 8 are structured to, and do, allow fluid (heated air, exhaust, etc.) and particles (smoke) to move from inside the enclosed space 4 to outside the enclosed space 4. It is understood that as hot air and exhaust move out of the enclosed space 4, the heat contained within the enclosed space 4 is reduced.

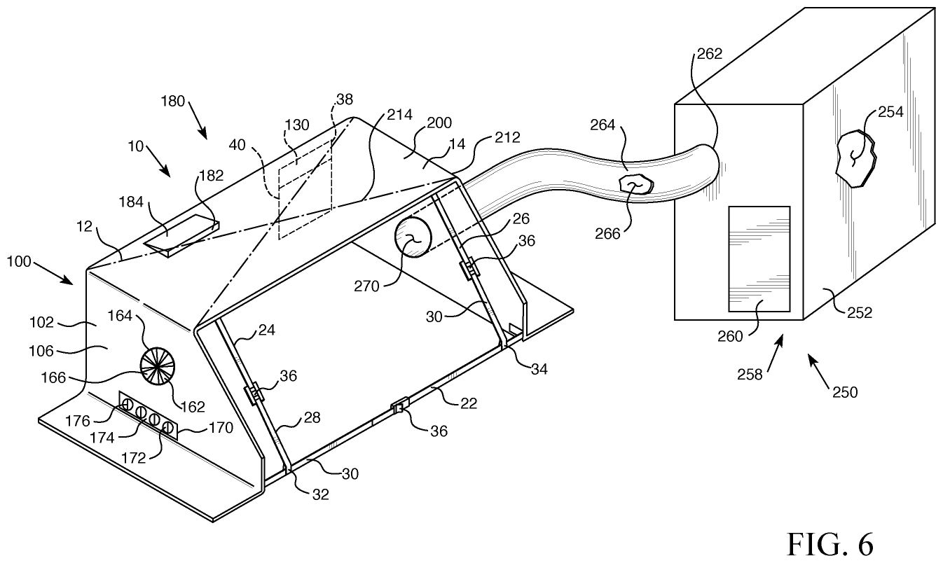

The grill converter device 10, in an exemplary embodiment, includes a heat resistant body 100 defining a sealing assembly 102 structured to limit fluid communication to a grill enclosed space 4. The grill converter device body 100 (alternately hereinafter “body” 100) includes a number of cover sections and is shown as two cover sections 12, 14. Alternatively, as shown in FIG. 6, the body 100 is a single cover section 106. As used herein, “heat resistant” means a material that is not damaged by temperatures over 150° F. The body 100 is structured to be, and is, coupled to the grill 1. That is, the body 100 includes a number of coupling components 110 structured to couple the body 100 to the grill 1. As shown, and in an exemplary embodiment, the coupling components 110 include, but are not limited to, the front straps 28, 30 discussed above. Further, as shown in FIG. 1, the body 100 is a “fitted” body. As used herein, “fitted” means that one element defines a cavity, void or hollow that corresponds, or snuggly corresponds, to another element and the “fitted” element is structured to, and does, generally enclose the other element. As used herein, a “fitted” body is, in and of itself, a “coupling component.” In an exemplary embodiment, not shown, the body 100 is a unitary fitted body 106 (FIG. 6). That is, the unitary fitted body 106 is structured to, and does, correspond to a specific model(s) of grill 1 or grill enclosure 3.

As shown in FIG. 1, the body 100, which in this embodiment includes the first cover section 12 and the second cover section 14, is an “adjustable fitted body.” As used herein, an “adjustable fitted body” corresponds to a plurality of specific models of grills and includes at least one adjustment assembly. That is, the body 100 corresponds to common characteristics of a plurality of specific models of grills such as, but not limited to, a contour, cross-sectional shape, height, or other dimensional characteristic. The body 100, however, does not correspond to all dimensional characteristics. For example, as shown, the adjustable fitted body 100 does not correspond to a set length. In this embodiment, the configuration as two overlapping cover sections 12, 14 and the plurality of laterally extending straps 16, 18, 20, 22 are, collectively, an adjustment assembly 104. In this configuration, the cover sections 12, 14 generally correspond to the dimensional characteristics of the grill 1, or grill enclosure 3, with the exception lateral length (or width). The body 100 is shown in a configuration that generally conforms to the contour of the grill 1, or grill enclosure 3, including lateral length. It is understood that another grill (not shown) has similar dimensional characteristics of the grill 1, or grill enclosure 3, with the exception lateral length (or width). To be fitted to such another grill 1, or grill enclosure 3, the adjustment assembly 104 is utilized so that the lateral length of the body 100 is adjusted so as to generally conform to different lateral lengths of the other grill 1, or grill enclosure 3. Thus, the body 100 is an “adjustable fitted body,” as defined above.

The sealing assembly 102 is structured to, and does, substantially block, i.e., obstruct, all, or substantially all, of the grill outlets 8 so as to alter, i.e., reduce, the minimum fluid flow rate through the grill enclosed space 4. That is, for the grill 1 shown, the outlets 8 are passages 9 through the lid 46 or base 5. It is understood that the outlets 8 may be disposed anywhere on the grill enclosure 3 and/or that the other grill enclosures are not shaped similarly to the grill 1 as shown. The passages 9, as shown in this exemplary embodiment, are generally openings and do not include other constructs such as, but not limited to, a flue, chimney, or similar conduit. Accordingly, the sealing assembly 102 for this embodiment is defined by the cover sections 12, 14. That is, in this embodiment, the cover sections 12, 14 are structured to, and do, extend over, i.e., cover, the outlets 8 and are disposed substantially against, the outer surface of the lid 46. That is, in an exemplary embodiment, the body 100 is generally “fitted” and the inner surface 13, 15 of the cover sections 12, 14 engages the outer surface of the lid 46. In this configuration, the outlets 8 are substantially blocked. Further, as shown, the body 100 includes “flaps” 120, 122, 124 that extend over the three out of four sides of the interface between the lid 46 and the base 5. The flaps 120, 122, 124 substantially block the flow of fluid through the interface between the lid 46 and the base 5. Further, the unblocked side of the interface between the lid 46 and the base 5 only allows for a minimal amount of fluid and smoke from the grill enclosed space 4 to escape. Thus, in this embodiment, the cover sections 12, 14 obstruct the outlets 8 thereby reducing the minimum fluid flow rate through the grill enclosed space 4. That is, because the cover sections 12, 14 are “fitted” the cover section inner surfaces 13, 15 block/obstruct the outlets 8. It is understood that, and as used herein, a “loose” cover for a grill 1 or grill enclosure 3, such as, but not limited to a protective cover does not block/obstruct the outlets 8 and, as such, a loose cover for a grill 1, or grill enclosure 3, does not include a sealing assembly 102 and is not a grill converter device 10.

Stated alternately, the body 100, i.e., the covers section 12, 14 as shown, include a number of upper rear portions 126 and a number of lower rear portions 128. The body upper rear portion 126 and body lower rear portion 128 are, in one exemplary embodiment, parts of a unitary body 106 and, in another embodiment, separate elements. For example, if the body 100 is made from fabric, the body upper rear portion 126 and body lower rear portion 128 are part of a unitary element. Conversely, if the body 100 is made from a rigid material, the body upper rear portion 126 and body lower rear portion 128 are separate elements. Further, if the body 100 includes a plurality of cover sections 12, 14, as shown in FIG. 1 then each cover section 12, 14 includes a body upper rear portion 126 and a body lower rear portion 128. Each cover lower rear portion 126 is movably coupled to an associated cover upper rear portion 128. For example, with a fabric body 100, the fabric is flexible along a fold line or a hinge 129 (a living hinge as shown). Conversely, with a body 100 made from rigid element, each cover lower rear portion 126 is coupled by a hinge not shown to an associated cover upper rear portion 128. That is, the hinge 129 includes living hinges (as shown) as well as barrel hinges, butt hinges and any other type of hinge. In this configuration, each upper rear portion 126 is structured to move with the grill lid 46 and each lower rear portion 128 is structured to move between a first position relative to the associated cover upper rear portion 126 and a second position relative to said associated cover upper rear portion 126 as the grill lid 46 moves between the open position and the closed position.

It is further noted that, in an exemplary embodiment, the side flaps 122, 124 include stiffening elements (not shown) such as, but not limited to, shape retention wires, i.e., stiff but bendable wires. The use of stiffening elements maintain the side flaps 122, 124 in an outwardly extending configuration when the lid 46 is moved between the first and second configurations so that the flaps 122, 124 do not move into the enclosed space 4.

In certain instances, it is desirable to allow some additional fluid flow through the grill enclosed space 4. As such, in an exemplary embodiment, the body 100 includes a number of flow adjustment assemblies 130 which are structured to selectably regulate fluid communication from a grill enclosed space 4. As used herein, “selectably regulate” means that a user controls, i.e., selects, the fluid flow that passes through a flow adjustment assembly 130. The selection is, in an exemplary embodiment, made by manually adjusting the flow adjustment assembly 130. In an alternate embodiment, not shown, the flow adjustment assembly 130 includes a controller, such as, but not limited to, a thermostat set by the user. That is, the controller is structured to, and does, move a valve assembly between an open configuration and a closed configuration when a selected temperature is reached.

Accordingly, in an exemplary embodiment, a flow adjustment assembly 130 includes a removable panel 132 on the body 100. That is, the flow adjustment assembly 130 includes a passage 134 in the body 100, a coupling assembly 136, and the removable panel 132. As shown, the flow adjustment assembly coupling assembly 136 is a hook-and-loop coupling with hook-and-loop material 140 disposed both adjacent, or about, the flow adjustment assembly passage 134 and on the flow adjustment assembly removable panel 132. In this configuration, the flow adjustment assembly removable panel 132 is structured to be moved between an installed configuration, wherein the flow adjustment assembly removable panel 132 is disposed substantially over the flow adjustment assembly passage 134 whereby the flow adjustment assembly 130 substantially obstructs the flow adjustment assembly passage 134, a partially installed configuration, wherein the flow adjustment assembly removable panel 132 is disposed partially over the flow adjustment assembly passage 134 whereby the flow adjustment assembly 130 partially obstructs the flow adjustment assembly passage 134, and an uninstalled position, wherein the flow adjustment assembly removable panel 132 is not disposed over the flow adjustment assembly passage 134 whereby the flow adjustment assembly 130 does not obstructs the flow adjustment assembly passage 134. As used herein, when the flow adjustment assembly 130 is in the uninstalled position, the sealing assembly 102 still substantially blocks, i.e., obstructs, substantially all of the grill outlets 8 so as to alter, i.e., reduce, the minimum fluid flow rate through the grill enclosed space 4. That is, even when the flow adjustment assembly 130 is in the uninstalled position, the grill converter device 10 still converts the grill 1 to a “smoker,” as defined above.

In an alternate embodiment, the flow adjustment assembly 130 is a “pinwheel” valve assembly 160. As used herein, a “pinwheel” valve assembly 160 includes a number of generally pie piece shaped (or stated in mathematical terms; a number of circular “sectors”) passages 162 in the body 100 and a generally disk shaped valve member 164 having corresponding pie piece shaped passages 166 in the valve member. The pinwheel valve assembly body passages 162 are disposed about a common center. Similarly, the pinwheel valve assembly valve member passages 166 are also disposed about a common center which is also the center of the pinwheel valve assembly valve member 164. As is known, the space between the pinwheel valve assembly valve member passages 166 is approximately the same as the size of the pinwheel valve assembly valve member passages 166. The center of the pinwheel valve assembly valve member 164 and the center of the pinwheel valve assembly body passages 162 are aligned and the pinwheel valve assembly valve member 164 is disposed immediately adjacent the body 100. As is known, a user rotates the pinwheel valve assembly valve member 164 so that the pinwheel valve assembly valve member passages 166 are either fully aligned (open configuration), partially aligned (partially open configuration), or not aligned (closed configuration) with the pinwheel valve assembly body passages 162.

In another alternate embodiment, the flow adjustment assembly 130 is a “sliding” valve assembly 170. As used herein, a “sliding” valve assembly 170 includes a number of passages 172 on the body 100. The sliding valve assembly body passages 172 are disposed generally linearly. The sliding valve assembly 170 also includes an elongated, generally planar valve member 174 having a plurality of passages 176 therein. The sliding valve assembly valve member passages 176 are disposed in a pattern (size, shape and spacing) that generally corresponds to the sliding valve assembly body passages 172. The sliding valve assembly valve member 174 is slidably coupled to the body and disposed immediately adjacent the sliding valve assembly body passages 172. The sliding valve assembly valve member 174 is structured to move/slide generally longitudinally so that the sliding valve assembly valve member passages 176 are either fully aligned (open configuration), partially aligned (partially open configuration), or not aligned (closed configuration) with the sliding valve assembly body passages 172.

In another embodiment, the flow adjustment assembly 130 is a “flapper” valve assembly 180. As used herein, a “flapper” valve assembly includes a number of passages 182 in the body 100 and a generally rigid valve member 184. The flapper valve assembly valve member 184 is, in an exemplary embodiment, also generally planar. The flapper valve assembly valve member 184 is pivotally coupled to the body 100 adjacent the flapper valve assembly passages 182. In this configuration, the flapper valve assembly valve member 184 is structured to, and does, move between a first position, wherein the flapper valve assembly valve member 184 covers the flapper valve assembly passages 182, and a second position, wherein the flapper valve assembly valve member 184 does not cover the flapper valve assembly passages 182.

Thus, in an exemplary embodiment, the body 100 is made from a number of flexible element(s). As used herein, a “flexible” element is a construct with no substantially rigid elements such as, but not limited to, a fabric construct. It is understood that a “flexible” element can be made of stiff fabric, such as, but not limited to, canvas, and can include certain elements that are more rigid than other elements. For example, a hemmed edge of a canvas element is still part of a “flexible” element even if the hemmed portion is stiffer than other portions of the canvas body and stiffer than a different fabric such as silk.

In an exemplary embodiment, as shown in FIG. 1, the number of cover sections 12, 14 (two as shown) include a plurality of flexible elements 190, 192. The flexible elements 190, 192 include a fabric body 194, 196. The flexible elements 190, 192 include a coupling 198 selected from the group consisting of a form fitted coupling (not numbered; it is inherent in the shape of the body 100), straps 16, 18, 20, 22, 24, 26 magnetic couplings 224. Further, each fabric body 194, 196 is structured to, and does, correspond to a portion of the grill 1, or grill enclosure 3. As shown, there are two fabric bodies 194, 196 each corresponding to generally half of the grill 1, or grill enclosure 3. In another embodiment, not shown, there are fabric bodies generally corresponding to each side or surface of the grill 1, or grill enclosure 3, or lid 46. That is, for example, there is a fabric body corresponding to the top side of the lid 46 and two fabric bodies corresponding to each lateral side of the lid 46. The separate fabric bodies are structured to be coupled, directly coupled, fixed, or mounted on the grill 1. Alternatively, the fabric bodies are structured to be coupled, directly coupled, or fixed to each other so as to form a fitted body 100, as described above.

In an alternate embodiment, the body 100 includes semi-rigid elements. As used herein, “semi-rigid elements” means a combination of flexible elements and rigid elements. For example, the body 100 in an exemplary embodiment includes rigid panels, not shown, disposed within a fabric shell. In this embodiment, the rigid panels are sized and shaped to correspond to the shape of the lid 46. That is, for example, there is a top rigid panel, two lateral side panels, and a back/rear panel. The fabric shell maintains the panels in a selected position(s) relative to each other and acts as a hinge, as described below.

In another alternate embodiment, the body 100 includes rigid elements. As used herein, “rigid elements” means that the body includes a number of generally still members, such as, but not limited to, insulated foam/poly material sheets (not shown). In one embodiment, individual sheets (not shown) are coupled, directly coupled, or fixed to the lid 46. In another embodiment, not shown, the sheets (not shown) are coupled to each other by a linkage assembly. The linkage assembly includes rigid members, hinges, and couplings that are structured to allow the sheets to move relative to each other. That is, in this embodiment, the body 100 includes number of cover sections 12, 14, two shown. Each cover section 12, 14 includes a rigid body 210, 212 and each rigid body 210, 212 is structured to be, and is, coupled, directly coupled, fixed, or mounted to the grill 1, the grill enclosure 3 and/or the lid 46.

Regardless of the material from which the body 100 is made, in an exemplary embodiment, the body 100 includes a number of insulated cover sections 220, 222. As used herein, an “insulated” cover section 220, 222 means that the cover sections 220, 222 are structured to, and do, resist heat transfer. In this configuration, the body 100 helps maintain the temperature in the grill enclosure 3 in addition to blocking the exhaust of smoke. Further, in an exemplary embodiment, the body 100 includes a thermometer 230 structured to measure the temperature inside the grill 1/grill enclosure 3.

Further, the grill converter device body 100 is, in an exemplary embodiment, structured to move between two configurations; a use, first configuration and a storage, second configuration. As used herein, when in the “use” configuration the body 100, i.e., the number of cover sections 12, 14, are configured to be coupled to the grill 1, or grill enclosure 3. Conversely, and as used herein, in the “storage” configuration, the body 100, i.e., the number of cover sections 12, 14, occupy a reduced volume. As used herein, a “reduced volume” of the body in the storage configuration is reduced relative to the volume of the body 100 in the use configuration.

Thus, a body 100 can move from the first configuration to the second configuration in a number of different manners. For example a flexible body 100 can move from the first configuration to the second configuration by being wadded up, i.e., randomly folded. In an exemplary embodiment, however, the body 100, and/or the individual cover sections 12, 14 are structured to, and do, move through a number of controlled transition configurations. As used herein, “controlled transition configurations” means that the body moves through the same intermediate configuration(s) when moving between the first and second configurations. For example, a flexible body 100, as well as a semi-rigid body 100 as described above, includes a number of fold lines 214 that are pre-folded, and/or weaker and less stiff portions of the flexible body 100. When the flexible body 100 is folded, the body naturally folds along the fold lines. In this configuration, the body, or the separate cover sections 12, 14 collapse and expand in a controlled manner similar to a “pop-up” construct in a child's pop-up book. The linkage assembly, not show, described above acts in a similar manner. That is, the linkage assembly causes the rigid elements to move through the same intermediate configuration(s) when moving between the first and second configurations. In an exemplary embodiment, when the body 100 is, or when the cover sections 12, 14 are, in the second configuration, the body 100, or each cover section 12, 14, is generally planar.

Further, the body 100, or each cover section 12, 14, is structured to be one of removably coupled to the grill 1, or grill enclosure 3, or mounted on the grill 1, or grill enclosure 3. As described above, when the body 100, or each cover section 12, 14, is removably coupled to the grill 1, the body 100, or each cover section 12, 14 is placed in the use configuration and disposed on the grill 1, or grill enclosure 3, when the user desires to convert the grill 1 into a smoker. A body 100, or each cover section 12, 14, that is removably coupled to the grill 1, or grill enclosure 3, includes a coupling selected from the group consisting of a fitted coupling (as described above), straps 16, 18 (as described above), or magnetic couplings 224. As an example, and as many grills 1 are made from a ferrous metal, a magnetic coupling 224 includes magnets 226 disposed in the body 100 or each cover section 12, 14. Alternatively, a grill (not shown) is configured with magnets at selected locations. The body 100, in this embodiment, includes ferrous elements or magnets at corresponding locations. Thus, when the body 100, or each cover section 12, 14 is disposed on the grill, the body 100, or each cover section 12, 14, is magnetically positioned and coupled to the grill.

In another embodiment, the body 100, or each cover section 12, 14 is “mounted” on the grill 1, or grill enclosure 3. As used herein, “mounting” means permanently coupling or semi-permanently coupling. A “permanent” coupling, as used herein, means that the elements can only be decoupled in a destructive manner. For example, foam/poly sheets that are bonded to the grill 1, or grill enclosure 3, are mounted in a “permanent” manner. As used herein, a “semi-permanent” coupling means a coupling that is not generally intended to be decoupled and, as such, includes “difficult to access fastener(s)” as defined above.

In another exemplary embodiment, the grill converter device 10 includes a “cold” smoker assembly 250. As used herein, and in the context of the term “cold smoker,” “cold” means a temperature that is less than the temperature in the grill enclosure 3. That is, some food such as, but not limited to, cheese, is smoked at a temperature below the temperatures experienced within the grill enclosure 3. The cold smoker assembly 250 includes a housing 252 defining an enclosed space 254. The cold smoker assembly housing 252 includes a movable, or removable, access assembly 258 such as, but not limited to a door 260. Further, in an exemplary embodiment, the cold smoker assembly housing 252 includes a flow adjustment assembly 130, as described above. The cold smoker assembly housing 252 also includes an inlet 262 and a cooling conduit 264 defining a passage 266. As used herein, a “cooling” conduit is a conduit that does not include any insulating material. The cooling conduit 264 is in fluid communication with the cold smoker assembly housing enclosed space 254.

In this embodiment, the body 100 includes a smoke outlet 270. As used herein, a “smoke” outlet is an outlet disposed near the highest elevation of the body 100 when the body 100 is in the use configuration. The cooling conduit 264 is in fluid communication with the body smoke outlet 270. Further, in an exemplary embodiment, the cold smoker assembly housing 252 is spaced from the body 100. In this configuration, smoke from within the grill enclosure 3 passes through the cooling conduit 264 into the smoker assembly housing enclosed space 254. As the smoke travels through the cooling conduit 264, the temperature of the fluid and smoke cools. Thus, the fluid and smoke in the cold smoker assembly 250 is reduced relative to the temperature of the fluid and smoke in the grill enclosure 3. In an alternate embodiment, the cooling conduit 264 is in direct fluid communication with one or more flow adjustment assemblies 130. That is, the cooling conduit 264 is coupled to and disposed about a flow adjustment assembly 130 outlet on either, or both, the body 100 and/or the cold smoker assembly housing 252.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1-20. (canceled)

21. A grill converter device structured to be situated on a grill, the grill converter device comprising:
a heat resistant body that is structured to be coupled to the grill;
the heat resistant body comprising a number of cover sections; and
at least one cover section of the number of cover sections being at least one of flexible and semi-rigid and comprising at least one flow adjustment assembly that is structured to selectably regulate fluid flow therethrough.

22. The grill converter device of claim 21 wherein the at least one flow adjustment assembly is structured to overlie at least one of a grill inlet and a grill outlet.

23. The grill converter device of claim 21 wherein the at least one flow adjustment assembly comprises at least one of a removable panel, a pinwheel valve, a sliding valve, and a flapper valve.

24. The grill converter device of claim 23 wherein the at least one flow adjustment assembly comprises a removable panel, and wherein the at least one cover section has a passage formed therein, the at least one cover section further comprising a hook and loop fastener that is structured to adjustably affix the removable panel to the at least one cover section at least one of adjacent and at least partially covering the passage.

25. The grill converter device of claim 21 wherein the heat resistant body is a fitted body.

26. The grill converter device of claim 21 wherein each cover section of the number of cover sections is structured to move between a use, first configuration wherein it occupies a first volume and is structured to be disposed on the grill and a storage, second configuration wherein it occupies a second volume less than the first volume and is removed from the grill.

27. The grill converter device of claim 26 wherein, as each cover section of the number of cover sections moves between the first and the second configurations, the cover section moves through a number of controlled transition configurations.

28. The grill converter device of claim 26 wherein when each cover section of the number of cover sections in the second configuration is substantially planar.

29. The grill converter device of claim 26 wherein each cover section of the number of cover sections is structured to be one of removably coupled to the grill and mounted to the grill.

30. The grill converter device of claim 21 wherein:
the at least one cover section comprises an upper rear portion and a lower rear portion;
the lower rear portion being movably coupled to the upper rear portion;
the upper rear portion being structured to be movable with a lid of the grill; and
the lower rear portion being structured to move between a first position relative to the upper rear portion and a second position relative to the upper rear portion that is different than the first position as the lid is moved between an open position and a closed position.

31. The grill converter device of claim 21 wherein:
the at least one cover section comprises a flexible element that comprises a fabric body; and
the fabric body being structured to correspond to a portion of the grill.

32. The grill converter device of claim 31 wherein the flexible element further comprises a coupling.

33. The grill converter device of claim 21 wherein the number of cover sections comprise a number of insulated cover sections.

34. The grill converter device of claim 21 wherein the body further comprises a thermometer that is structured to register a value that is representative of a temperature within an interior of the grill.

35. The grill converter device of claim 21 wherein the body further comprises a cold smoker assembly.

36. The grill converter device of claim 35 wherein:
the body comprises a smoke outlet;
the cold smoker assembly comprises a housing having an enclosed space; and
the smoke outlet is in fluid communication with the enclosed space.

37. The grill converter device of claim 36 wherein the cold smoker assembly further comprises a cooling conduit that provides fluid communication between the smoke outlet and the enclosed space.

38. The grill converter device of claim 37 wherein the housing is spaced from the body.
